(19) United States
(12) Patent Application Publication
(10) Pub. No.: US 2026/0018340 A1
(43) Pub. Date: Jan. 15, 2026

(54) MULTILAYER CERAMIC ELECTRONIC COMPONENT

(71) Applicant: Murata Manufacturing Co., Ltd., Nagaokakyo-shi (JP)

(72) Inventors: Kota ZENZAI, Nagaokakyo-shi (JP); Tadateru YAMADA, Nagaokakyo-shi (JP); Shinobu CHIKUMA, Nagaokakyo-shi (JP); Yusuke KAMATA, Nagaokakyo-shi (JP); Tomoki KITAGAWA, Nagaokakyo-shi (JP)

(21) Appl. No.: 19/338,092

(22) Filed: Sep. 24, 2025

Related U.S. Application Data
(63) Continuation of application No. PCT/JP2024/000954, filed on Jan. 16, 2024.

(30) Foreign Application Priority Data
Mar. 30, 2023 (JP) 2023-055772

(51) Int. Cl. H01G 4/224; H01G 2/06; H01G 2/24; H01G 4/232; H01G 4/30

(52) U.S. Cl. CPC H01G 4/224; H01G 2/065; H01G 2/24; H01G 4/232; H01G 4/30

(57) ABSTRACT

A multilayer ceramic electronic component includes a capacitor body including a stacked body and two external electrodes on each of two end surfaces of the stacked body, connected to an internal electrode layer, and covering a portion of a main surface, and two spacers respectively on end surface sides of one main surface side of the capacitor body and sandwiching the external electrodes, and a reinforcing material having a spacer-side covering portion covering at least about 4.9% of each of the two spacers in a stacking direction and a capacitor-side covering portion extending from the spacer-side covering portion and covering the spacer side of an outer periphery of the capacitor body. The spacer-side covering portion continuously covers opposing spacer end surfaces opposing one other between the two spacers, and two spacer side surfaces.

### CROSS REFERENCE TO RELATED APPLICATIONS

This application claims the benefit of priority to Japanese Patent Application No. 2023-055772 filed on Mar. 30, 2023 and is a Continuation application of PCT Application No. PCT/JP2024/000954 filed on Jan. 16, 2024. The entire contents of each application are hereby incorporated herein by reference.

### BACKGROUND OF THE INVENTION

### 1. Field of the Invention

The present invention relates to multilayer ceramic electronic components such as multilayer ceramic capacitors.

### 2. Description of the Related Art

Multilayer ceramic electronic components such as multilayer ceramic capacitors are widely used in various electronic devices such as mobile terminal devices including mobile phones and personal computers. Such multilayer ceramic capacitors each include a rectangular parallelepiped-shaped multilayer body in which dielectric layers and internal electrode layers are alternately laminated, and external electrodes provided at both opposed ends of the multilayer body.

The multilayer ceramic capacitors each include an inner layer portion in which the dielectric layers and the internal electrodes are alternately stacked. Then, dielectric layers defining and functioning as outer layer portions are provided at the top and bottom of the inner layer portion to form a rectangular parallelepiped-shaped multilayer body, and external electrodes are provided on both end surfaces in the longitudinal direction of the multilayer body to form a capacitor main body.

Furthermore, in order to suppress the occurrence of “acoustic noise”, multilayer ceramic capacitors have been known that each include a spacer that covers a portion of the external electrode on a side of the capacitor main body to be mounted on a substrate.

In each of the multilayer ceramic electronic components described in Japanese Unexamined Patent Application, Publication No. 2015-216337, an electrically conductive resin is used as a spacer material and plating is provided thereon. However, the electrically conductive resin layer has poor electric conductivity, which increases the ESR (equivalent series resistance) of each of the multilayer ceramic electronic components. Therefore, there are also multilayer ceramic capacitors that suppress acoustic noise while ensuring conductivity by forming spacers with metal, but when spacers are formed with metal, resistance related to bending strength is weak.

### SUMMARY OF THE INVENTION

Example embodiments of the present invention provide multilayer ceramic electronic components each with improved bending strength while reducing or preventing acoustic noise.

A multilayer ceramic electronic component according to an example embodiment of the present invention includes a capacitor main body including a multilayer body including dielectric layers and internal electrode layers laminated, two main surfaces opposed to each other in a lamination direction, two end surfaces opposed to each other in a length direction intersecting the lamination direction, and two lateral surfaces opposed to each other in a width direction intersecting the lamination direction and the length direction, and two external electrodes each on a corresponding one of the two end surfaces, each connected to the internal electrode layers, the two external electrodes each extending to the two main surfaces and covering a portion of each of the two main surfaces, and two spacers on one of the two main surfaces of the capacitor main body, the two spacers being respectively adjacent to one of the two end surfaces and adjacent to an other of the two end surfaces, each of the spacers including two spacer main surfaces opposed to each other in the lamination direction, two spacer end surfaces opposed to each other in the length direction, and two spacer lateral surfaces opposed to each other in the width direction, and a reinforcement portion, in which the reinforcement portion includes a spacer-side covering portion covering about 4.9% or more of the length in the lamination direction of the spacer, and a capacitor-side covering portion that continuously extends from the spacer-side covering portion to cover a periphery of the capacitor main body adjacent to the two spacers, and the spacer-side covering portion continuously covers opposing spacer end surfaces opposed to each other between the two spacers, and the spacer lateral surfaces in the spacer.

According to example embodiments of the present invention, multilayer ceramic electronic components each with improved bending strength while suppressing acoustic noise are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view taken along the line II-II in FIG. 1 of the multilayer ceramic capacitor 1.

FIG. 3 is a cross-sectional view taken along the line III-III in FIG. 1 of the multilayer ceramic capacitor 1.

FIG. 4 is an enlarged view of a portion of a spacer 4 in the cross-sectional view of the multilayer ceramic capacitor 1 shown in FIG. 2.

FIGS. 5A to 5E are diagrams explaining the covering state of the spacer-side covering portion 52 in the reinforcement portion 5, where 5A, 5B, 5C show example embodiments of the present invention, and 5D, 5E show comparative examples.

FIGS. 6A to 6C are diagrams explaining the covering state of the capacitor main body 1A by the capacitor-side covering portion 51 of the reinforcement portion 5.

FIG. 7 is a flowchart explaining a manufacturing method of the multilayer ceramic capacitor 1 according to an example embodiment of the present invention.

FIGS. 8A to 8D are diagrams explaining a multilayer body manufacturing step S1 and an external electrode formation step S2.

FIGS. 9A to 9C are diagrams explaining a spacer placement step S3.

FIGS. 10A to 10C are diagrams explaining a reinforcement portion placement step S4.

FIG. 11 is a table showing the results of evaluation 1 and evaluation 2 performed on the multilayer ceramic capacitor 1 provided with the reinforcement portion 5 according to an example embodiment of the present invention.

### DETAILED DESCRIPTION OF THE EXAMPLE EMBODIMENTS

Example embodiments of the present invention will be described in detail below with reference to the drawings.

In the following, a multilayer ceramic capacitor 1 will be described as an example of a multilayer ceramic electronic component according to an example embodiment of the present invention, but the present invention is not limited thereto. Also, the drawings may be schematically simplified to explain the contents of the present invention, and the ratio of dimensions of the components or between components depicted may not match the ratio of their dimensions described in the specification. Also, components described in the specification may be omitted from the drawings, or the number of components may be reduced in the drawings.

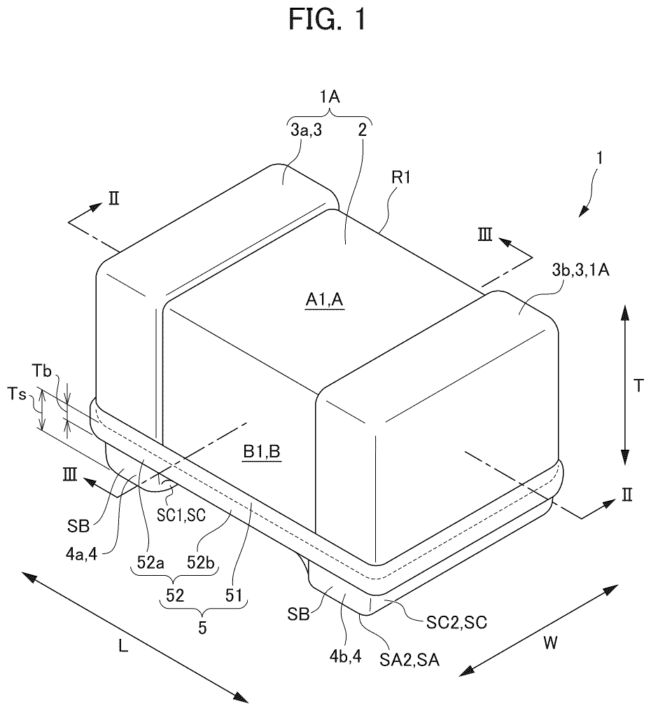

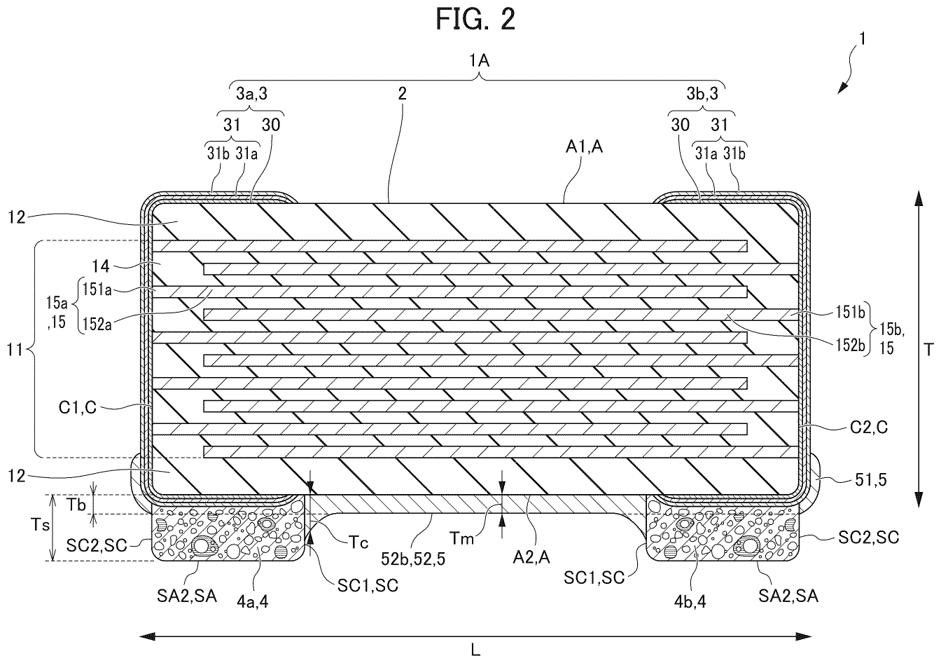

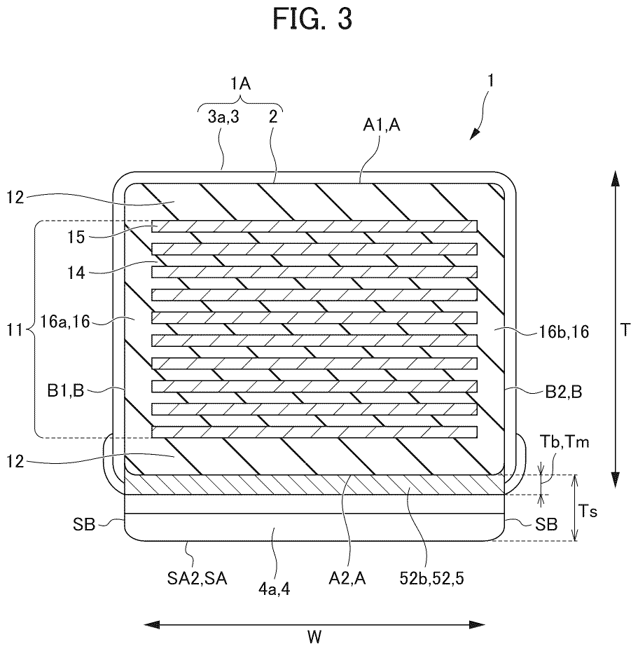

FIG. 1 is a schematic perspective view of a multilayer ceramic capacitor 1 according to an example embodiment of the present invention. FIG. 2 is a cross-sectional view taken along the line II-II in FIG. 1 of the multilayer ceramic capacitor 1 according to the example embodiment. FIG. 3 is a cross-sectional view taken along the line III-III in FIG. 1 of the multilayer ceramic capacitor 1 according to the present example embodiment.

The multilayer ceramic capacitor 1 has a rectangular or substantially rectangular parallelepiped shape, and includes a capacitor main body 1A including a multilayer body 2 and a pair of external electrodes 3 provided at both ends of the multilayer body 2, spacers 4 attached to the capacitor main body 1A, and a reinforcement portion 5 that covers a portion of each of the spacers 4 and a portion of the capacitor main body 1A. The multilayer body 2 includes an inner layer portion 11 including dielectric layers 14 and internal electrode layers 15 laminated together.

In the following description, as a term representing the orientation of the multilayer ceramic capacitor 1, the direction in which the pair of external electrodes 3 are provided in the multilayer ceramic capacitor 1 is defined as the length direction L. The direction in which the dielectric layers 14 and the internal electrode layers 15 are stacked (or laminated) is defined as the lamination direction T. The direction intersecting both the length direction L and the lamination direction T is defined as the width direction W.

In addition, in example embodiments of the present invention, the width direction W is orthogonal or substantially orthogonal to both the length direction L and the lamination direction T.

### Outer Surface of Multilayer Body 2

Among the six outer surfaces of the multilayer body 2, a pair of outer surfaces opposed to each other in the lamination direction T is defined as a first main surface A1 and a second main surface A2, a pair of outer surfaces opposed to each other in the width direction W is defined as a first lateral surface B1 and a second lateral surface B2, and a pair of outer surfaces opposed to each other in the length direction L is defined as a first end surface C1 and a second end surface C2. When there is no need to particularly distinguish between the first main surface A1 and the second main surface A2, they are collectively referred to as main surfaces A, when there is no need to particularly distinguish between the first lateral surface B1 and the second lateral surface B2, they are collectively referred to as lateral surfaces B, and when there is no need to particularly distinguish between the first end surface C1 and the second end surface C2, they are collectively referred to as end surfaces C.

The multilayer body 2 preferably has rounded ridge portions R1 including corner portions. The ridge portions R1 are portions where two surfaces of the multilayer body 2 intersect, i.e., the main surface A and the lateral surface B, the main surface A and the end surface C, or the lateral surface B and the end surface C intersect.

### Multilayer Body 2

The multilayer body 2 includes an inner layer portion 11 that generates capacitance, outer layer portions 12 sandwiching the inner layer portion 11 from the lamination direction T, and side gap portions 16 sandwiching the inner layer portion 11 and the outer layer portions 12 from the width direction W.

### Inner Layer Portion 11

The inner layer portion 11 includes dielectric layers 14 and internal electrode layers 15 alternately laminated along the lamination direction T.

### Dielectric Layer 14

The dielectric layers 14 are each made of a ceramic material. As the ceramic material, for example, a dielectric ceramic with BaTiO₃ as a main component is used.

### Internal Electrode Layer 15

The internal electrode layers 15 include a plurality of first internal electrode layers 15a and a plurality of second internal electrode layers 15b. The first internal electrode layers 15a and the second internal electrode layers 15b are alternately provided. The first internal electrode layers 15a each include a first counter portion 152a opposed to a corresponding one of the second internal electrode layers 15b, and a first extension portion 151a extending from the first counter portion 152a toward the first end surface C1. The end portion of the first extension portion 151a is exposed at the first end surface C1 and is electrically connected to the first external electrode 3a described later. The second internal electrode layers 15b each include a second counter portion 152b opposed to a corresponding one of the first internal electrode layers 15a, and a second extension portion 151b extending from the second counter portion 152b toward the second end surface C2. The end portion of the second extension portion 151b is electrically connected to the second external electrode 3b described later. Electric charge is accumulated in the first counter portion 152a of the first internal electrode layer 15a and the second counter portion 152b of each of the second internal electrode layers 15b.

The internal electrode layers 15 are preferably made of a metal material such as, for example, nickel (Ni), copper (Cu), silver (Ag), palladium (Pd), silver-palladium (Ag—Pd) alloy, gold (Au), etc.

### Outer Layer Portion 12

The outer layer portion 12 can be made of the same material as the dielectric layers 14 of the inner layer portion 11.

### Side Gap Portion 16

The side gap portions 16 sandwich the inner layer portion 11 and the outer layer portion 12 from the width direction W. The side gap portions 16 include a first side gap portion 16a that defines and functions as the first lateral surface B1 of the multilayer ceramic capacitor 1, and a second side gap portion 16b that defines and functions as the second lateral surface B2 of the multilayer ceramic capacitor 1. The side gap portion 16 can be made of the same material as the dielectric layer 14.

### External Electrode 3

The external electrode 3 includes a first external electrode 3a provided on the first end surface C1, and a second external electrode 3b provided on the second end surface C2. The external electrode 3 covers not only the end surface C, but also a portion of the main surface A and a portion of the lateral surface B continuous with the end surface C.

As described above, the end portion of the first extension portion 151a of each of the first internal electrode layers 15a is exposed at the first end surface C1 and electrically connected to the first external electrode 3a. Furthermore, the end portion of the second extension portion 151b of each of the second internal electrode layers 15b is exposed at the second end surface C2, and is electrically connected to the second external electrode 3b. This provides a configuration in which a plurality of capacitor elements are electrically connected in parallel between the first external electrode 3a and the second external electrode 3b.

The external electrodes 3 each include, for example, a base electrode layer 30 and a plated layer 31. However, it is not necessarily required that the external electrode 3 includes such a layered configuration.

The base electrode layer 30 is formed, for example, by applying and firing an electrically conductive paste including copper (Cu). The base electrode layer 30 may also include glass and ceramic material. The configuration of the base electrode layer 30 is not limited thereto.

The plated layer 31 includes, for example, a nickel (Ni) plated layer 31a provided on the surface of the base electrode layer 30, and a tin (Sn) plated layer 31b provided on the surface of the nickel (Ni) plated layer 31a. The configuration of the plated layer 31 is not limited thereto.

### Spacer 4

The spacer 4 includes a pair of a first spacer 4a and a second spacer 4b. The first spacer 4a is provided on the second main surface A2, which is a substrate mounting surface of the capacitor main body 1A, and adjacent to the end surface C1 located on one side in the length direction L. The second spacer 4b is provided on the second main surface A2 and adjacent to the end surface C2 located on the other side in the length direction L. Each spacer 4 connects with a portion of the external electrode 3 provided on the second main surface A2. When the substrate mounting surface of the capacitor main body 1A is the first lateral surface B1, the first spacer 4a is provided on the first lateral surface B1, which is a substrate mounting surface of the capacitor main body 1A, and adjacent to the end surface C1 located on one side in the length direction L. The second spacer 4b is provided on the first lateral surface B1 and adjacent to the end surface C2 located on the other side in the length direction L.

In the following, in each spacer 4, the two surfaces that are opposed to each other in the lamination direction T are defined as spacer main surfaces SA, the two surfaces that are opposed to each other in the length direction L are defined as spacer end surfaces SC, and the two surfaces that are opposed to each other in the width direction W are defined as spacer lateral surfaces SB.

In addition, among the two spacer end surfaces SC, a spacer end surface SC adjacent to the middle portion in the length direction L of the capacitor main body 1A is defined as a middle-side spacer end surface SC1, and a spacer end surface SC on the outer side in the length direction L of the multilayer body 2 is defined as an outer-side spacer end surface SC2.

Among the two spacer main surfaces SA, the spacer main surface SA adjacent to the capacitor main body 1A is defined as the main body-side spacer main surface SA1, and the spacer main surface SA on the other side is defined as the mounting-side spacer main surface SA2. When the substrate mounting surface of the capacitor main body 1A is the first lateral surface B1, among the two spacer lateral surfaces SB, the spacer lateral surface SB adjacent to the capacitor main body 1A is defined as the main body-side spacer lateral surface SB1, and the spacer lateral surface SB on the other side is defined as the mounting-side spacer main surface SB2.

In the present example embodiment, the length in the length direction L of each of the spacers 4 is longer than a corresponding one of the external electrodes 3 provided on the second main surface A2. That is, the middle-side spacer end surface SC1 of each spacer 4 is located beyond a corresponding one of the external electrodes 3 in the length direction L. This provides a portion where the main body-side spacer main surface SA1 of each of the spacers 4 is in direct contact with the second main surface A2 of the multilayer body 2. However, the present invention is not limited thereto, and the length in the length direction L of each spacer 4 may be shorter than a corresponding one of the external electrodes provided on the second main surface A2. The same also applies when the substrate mounting surface of the capacitor main body 1A is the first lateral surface B1.

In the present example embodiment, the external electrodes 3 each include the base electrode layer 30 and the plated layer 31 that covers the base electrode layer 30, and each spacer 4 is provided on the surface of the plated layer 31. However, for example, each spacer 4 may be provided on the surface of the base electrode layer 30, and a second plated layer may cover each spacer 4 and the base electrode layer 30. By providing the second plated layer, the bonding strength between each spacer 4 and the base electrode layer 30 is improved.

### Material of Spacer 4

Each spacer 4 includes, for example, either copper (Cu) or nickel (Ni) as metal powder and tin (Sn). The copper (Cu) and nickel (Ni) may be coated with silver (Ag), for example. In addition, for example, each spacer 4 may further include silver (Ag) as a metal including an intermetallic compound.

The intermetallic compound formed by adding tin (Sn) to either copper (Cu) or nickel (Ni) has a melting point such that will not melt even when soldering is performed when mounting the multilayer ceramic capacitor 1 on a wiring board, and no deformation due to heat occurs. Therefore, the shape of each spacer 4 can be reliably maintained, and it is possible to provide each spacer 4 while maintaining the desired configuration even during soldering. In particular, for example, an intermetallic compound formed by adding tin (Sn) to an alloy of copper (Cu) and nickel (Ni) is preferable as a component for forming each spacer 4.

The metal region MP formed by the metal powder may include a phenol resin, for example. The phenol resin coats the intermetallic compound particles and is scattered to fill the gaps between the particles. The phenol resin may not completely coat the intermetallic compound particles. In addition, by using a phenol resin, the amount of gas generated during the heat treatment when forming each spacer 4 can be reduced, thus reducing voids in each spacer 4. The phenol resin may be exposed on the surface of each spacer 4 and cover at least a portion of the surface of each spacer 4. By covering the surface of each spacer 4 with a phenol resin, the smoothness of the surface of each spacer 4 is improved, and the mechanical strength of each spacer 4 can be increased.

Examples of the phenol resin include novolac-type phenol resins such as a phenol novolac resin, a phenol aralkyl resin, a cresol novolac resin, a tert-butylphenol novolac resin, and a nonylphenol novolac resin, a resol-type phenol resin, polyoxystyrenes such as polyparaoxystyrene, or the like.

The area ratio of a phenol resin in each of the spacers 4 is, for example, preferably about 1% or more and about 20% or less, and particularly preferably about 5% or more and about 15% or less, in the LT cross-section perpendicular or substantially perpendicular to the width direction W of each of the spacers 4. If it is less than about 18, the advantageous effects of the phenol resin cannot be sufficiently achieved, and if it exceeds about 20%, there is a risk that the bonding strength of each of the spacers to the external electrode will decrease.

As a method for determining the area ratio (%) of a phenol resin in each of the spacers 4, for example, one spacer 4 is polished in the width direction W to the middle position in the width direction W, and the polished surface is magnified about 50 times with a microscope (BX-51) and photographed with a digital camera for microscopes (DP22 manufactured by Olympus). The obtained image is binarized to separate the metal region MP and the resin region RP, and from the areas of the metal region MP, metal powder MF, resin region RP, and void P, the area ratio (%) of a phenol resin can be calculated by the formula: (area ratio (%) of a phenol resin)=(area of resin region RP)/(area of metal region MP+area of metal powder MF+area of resin region RP+area of void P)×100.

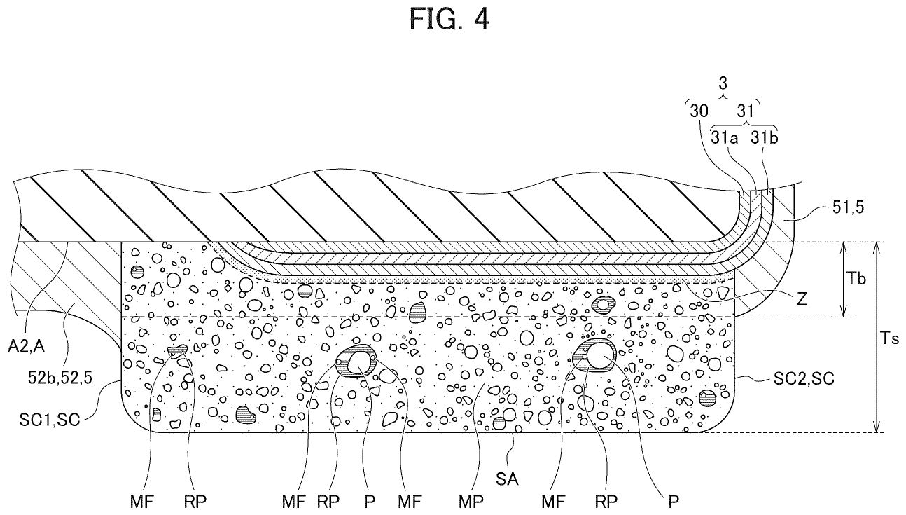

FIG. 4 is an enlarged view of a portion of one of the spacers 4 in the cross-sectional view of the multilayer ceramic capacitor 1 shown in FIG. 2. As shown in FIG. 4, the resin region RP formed by a phenol resin may include the metal powder MF. The metal powder MF reduces or prevents the shrinkage of the phenol resin, and can relax the compressive stress due to the phenol resin.

The spacer 4 preferably has a void ratio of, for example, about 20% or less in the region Z within about 5 μm from the interface with a corresponding one of the external electrodes 3. By keeping the void ratio low, the bonding area of the spacer 4 that bonds with the external electrode 3 increases, thus improving the bonding strength with the external electrode 3.

Inside the spacer 4, voids P are formed, and the maximum diameter of the voids P is, for example, preferably about ½ the maximum dimension or less in the thickness of the spacer 4 in the lamination direction T. If it exceeds about ½, cracks are likely to occur with the voids P as starting points, reducing the strength of the spacer 4. When the substrate mounting surface of the capacitor main body 1A is the first lateral surface B1, the maximum diameter of the voids P formed inside the spacer 4 is, for example, preferably about ½ the maximum dimension or less in the thickness of the spacer 4 in the width direction W.

As a method for determining the void ratio (%), for example, the spacer 4 is polished in the width direction W to the middle position in the width direction W, and the polished surface is magnified about 50 times with a microscope (BX-51) and photographed with a digital camera for microscopes (DP22 manufactured by Olympus). The obtained image is binarized to separate the metal region MP and the void P portions, and the void ratio (%) can be calculated by the formula: void ratio (%)=(area of void P)/(area of metal region MP+area of metal powder MF+area of resin region RP+area of void P)×100, from the respective areas of the metal region MP, metal powder MF, resin region RP, and void P.

In the above, a configuration including metal intermetallic compounds and a phenol resin is shown as an example of the spacer material, but the present invention is not limited thereto, and, for example, may include different types of metal components, or may include resins such as an epoxy resin and rosin, or glass components in addition to a phenol resin. Also, it may be formed without including a resin. It may be manufactured with, for example, a material including copper or copper alloy, and provided to be connected via Ni plating and solder.

When the spacer 4 is smaller than the external electrode 3 in a plan view from the direction connecting the surface to which the spacer 4 is applied and the surface opposed to that surface, it is preferable to provide a direction identification mark to at least a portion of the spacer 4. The direction identification mark indicates the direction for opposing the second main surface A2 or the first lateral surface B1 where the spacer 4 is provided toward the wiring board when mounting the multilayer ceramic capacitor 1 on the wiring board, and can include, for example, coloring the spacer 4 with a color different from the external electrode 3, printing a direction an identification mark such as a QR code (registered trademark) for identifying the direction, or providing a recessed portion in a portion of the multilayer body. As a coloring, the phenol resin included in the spacer 4 may be exposed on the surface of the spacer 4 to have a color different from the external electrode 3. Also, the direction identification mark may be provided on the multilayer body 2, and is not limited to the spacer 4. Even when the spacer 4 is larger than the external electrode 3, a direction identification mark may be provided.

For example, when the color tone of the spacer 4 and the external electrode 3 are the same, it may not be possible to determine which side has the surface to which the spacer 4 is applied when viewed from above, potentially causing image processing errors. However, by providing a direction identification mark, such image processing errors can be prevented.

### Reinforcement Portion 5

As shown in FIG. 1, the reinforcement portion 5 includes a capacitor-side covering portion 51 that covers a predetermined length of the capacitor main body 1A in the lamination direction T, and a spacer-side covering portion 52 that is continuously provided from the capacitor-side covering portion 51 and located adjacent to the spacers 4. When the substrate mounting surface of the capacitor main body 1A is the first lateral surface B1, the reinforcement portion 5 includes a capacitor-side covering portion 51 that covers a predetermined length of the capacitor main body 1A in the width direction W, and a spacer-side covering portion 52 that is continuously provided from the capacitor-side covering portion 51 and located adjacent to the spacer 4.

### Material of Reinforcement Portion 5

The reinforcement portion 5 includes an insulating resin, and in an example embodiment of the present invention, the reinforcement portion 5 is mainly made of an insulating resin. The surface of the insulating resin may be coated with an insulating water-repellent treatment agent. By forming the reinforcement portion 5 with an insulating resin, the bending strength is improved, and by coating it with an insulating water-repellent treatment agent, the moisture resistance is further improved. The insulating resin may include, for example, ceramics, glass, etc. Also, the reinforcement portion 5 preferably has higher bonding strength with the multilayer body 2 than metal intermetallic compounds. For example, the reinforcement portion 5 may include an epoxy resin as a main component, combined with a phenol resin as a curing agent. As other curing agents, for example, a curing agent of an acid anhydride system, amine system, ester system or the like can be used. A curing accelerator may also be added to the epoxy resin. It may also be formed only with a water-repellent treatment agent.

### Shape of Reinforcement Portion 5

### Spacer-Side Covering Portion 52

The spacer-side covering portion 52 includes lateral portions 52a that cover the two spacer lateral surfaces SB of the two spacers 4, and a middle portion 52b that is provided between the middle-side spacer end surface SC1 of one spacer 4 and the middle-side spacer end surface SC1 of the other spacer 4, and covers a portion of the capacitor main body 1A (multilayer body 2) adjacent to the second main surface A2. The middle portion 52b covers each of the middle-side spacer end surfaces SC1 of the two spacers 4.

As shown in FIG. 2, in the present example embodiment, in the middle portion 52b, when the length Tm in the lamination direction T at the middle portion in the length direction L of the capacitor main body 1A (multilayer body 2) and the length Tc in the lamination direction T at the middle-side spacer end surface SC1 are defined, the relationship therebetween is Tm<Tc.

In the present example embodiment, the middle portion 52b connects the middle-side spacer end surface SC1 of one spacer 4 and the middle-side spacer end surface SC1 of the other spacer 4. However, the middle portion 52b does not necessarily need to be continuous between the first spacer 4a and the second spacer 4b. The middle portion 52b may be discontinuously provided by dividing it into a portion that covers the middle-side spacer end surface SC1 of the first spacer 4a and a portion of the capacitor main body 1A (multilayer body 2) adjacent to of the second main surface A2, and a portion that covers the middle-side spacer end surface SC1 of the second spacer 4b and a portion of the capacitor main body 1A (multilayer body 2) adjacent to the second main surface A2.

In the present example embodiment, the spacer-side covering portion 52 further covers the outer-side spacer end surface SC2, but the present invention is not limited thereto, and the spacer-side covering portion 52 may not cover the outer-side spacer end surface SC2.

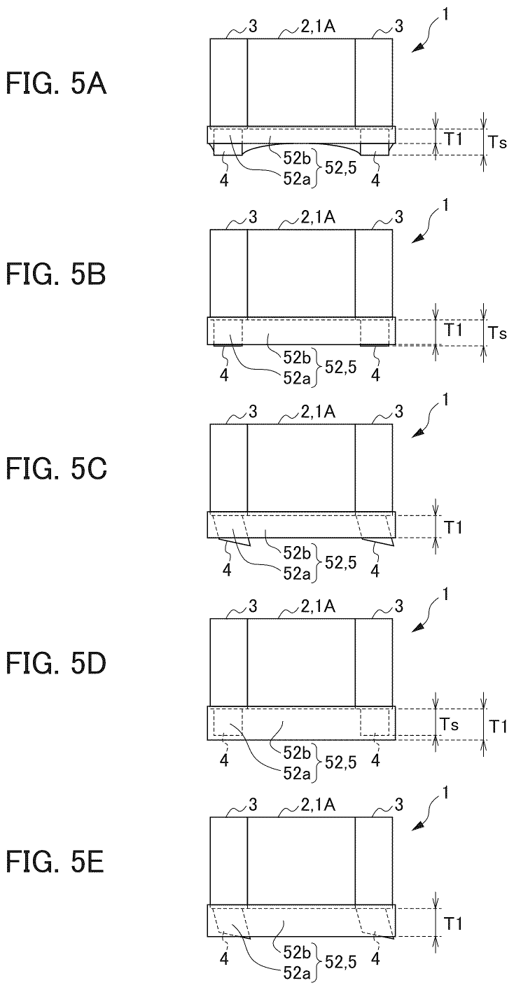

FIGS. 5A to 5E are diagrams explaining the covering state of the spacer-side covering portion 52 of the reinforcement portion 5, where FIGS. 5A to 5C show example embodiments of the present invention, and FIGS. 5D and 5E show comparative examples. In one example embodiment of the present invention, when the lamination direction length (total length) of the spacer 4 is defined as Ts and the lamination direction length at the lateral portion 52a of the spacer-side covering portion 52 of the reinforcement portion 5 is defined as T1, the length T1 in the lamination direction of the lateral portion 52a is, for example, about 4.9% or more of the length Ts in the lamination direction of the spacer 4. As described later, since the lateral portion 52a does not cover the mounting-side spacer main surface SA2 among the spacer main surfaces SA of the spacer 4, it is less than 100%. That is, for example, 0.049≤T1/Ts<1.

FIG. 5A shows a case where T1/Ts is, for example, about 0.5, and FIG. 5B shows a case where T1/Ts is, for example, about 0.95.

FIG. 5C shows a case where the mounting-side spacer main surface SA2 is sloped with respect to the main body-side spacer main surface SA1. In FIG. 5C, T1/Ts is, for example, about 0.7 at the portion of the mounting-side spacer main surface SA2 that is farthest from the main body-side spacer main surface SA1, but T1/Ts is about 1 at the portion of the mounting-side spacer main surface SA2 that is closest to the main body-side spacer main surface SA1. However, even at the portion of the mounting-side spacer main surface SA2 that is closest to the main body-side spacer main surface SA1, the reinforcement portion 5 does not extend to the mounting-side spacer main surface SA2, and the reinforcement portion 5 is not provided on the mounting-side spacer main surface SA2.

FIG. 5D shows a comparative example where T1/Ts is greater than 1, and the reinforcement portion 5 is also provided on the mounting-side spacer main surface SA2.

FIG. 5E shows a comparative example where the mounting-side spacer main surface SA2 is sloped with respect to the main body-side spacer main surface SA1. Unlike the case in FIG. 5C, T1/Ts is, for example, about 0.9 at the portion of the mounting-side spacer main surface SA2 that is farthest from the body-side spacer main surface SA1, but T1/Ts is 1 or more at the portion of the mounting-side spacer main surface SA2 that is closest to the main body-side spacer main surface SA1. Further, at the portion of the mounting-side spacer main surface SA2 that is closest to the main body-side spacer main surface SA1, the reinforcement portion 5 exists on the mounting-side spacer main surface SA2.

In the comparative examples shown in FIGS. 5D and 5E, since the reinforcement portion 5 extends to the mounting-side spacer main surface SA2, when mounting the multilayer ceramic capacitor 1 on a substrate, the presence of the reinforcement portion 5 hinders electrical conduction between the spacer 4 and the substrate. In addition, when the reinforcement portion 5 covers the mounting-side spacer main surface SA2 of the spacer 4, solder does not adhere to the spacer 4 during mounting, which may increase the possibility of mounting failures.

However, in FIGS. 5A to 5C which show example embodiments of the present invention, since the reinforcement portion 5 is not present on the mounting-side spacer main surface SA2, it is possible to ensure good electrical conduction between the spacers 4 and the substrate, that is, good electrical conduction between the substrate and the external electrodes 3. Further, since the solder and the spacer 4 are fixed together at the time of mounting, it is possible to reduce the possibility of mounting failure.

It is preferable that the reinforcement portion 5 is not provided between the external electrodes 3 and the spacers 4 on the main body-side spacer main surface SA1 of the spacers 4. Since the reinforcement portion 5 is not provided between the external electrodes 3 and the spacers 4, it is possible to ensure the electrical connection between the external electrodes 3 and the spacers 4.

However, in a case where there is a gap between the spacers 4 and a portion of the second main surface A2 of the multilayer body 2 where the external electrode 3 is not provided, the reinforcement portion 5 may be provided to enter into the gap. Since the bonding area between the reinforcement portion 5 and the spacers 4 increases by the reinforcement portion 5 entering into the gap, the fixing strength increases. In addition, when the gap is not completely filled with the reinforcement portion 5, it is possible to mitigate the transmission of vibration by the gap.

It is preferable that the reinforcement portion 5 covers a larger area on surfaces other than the spacer main surface SA, as this improves the reinforcement effect.

### Capacitor-Side Covering Portion 51

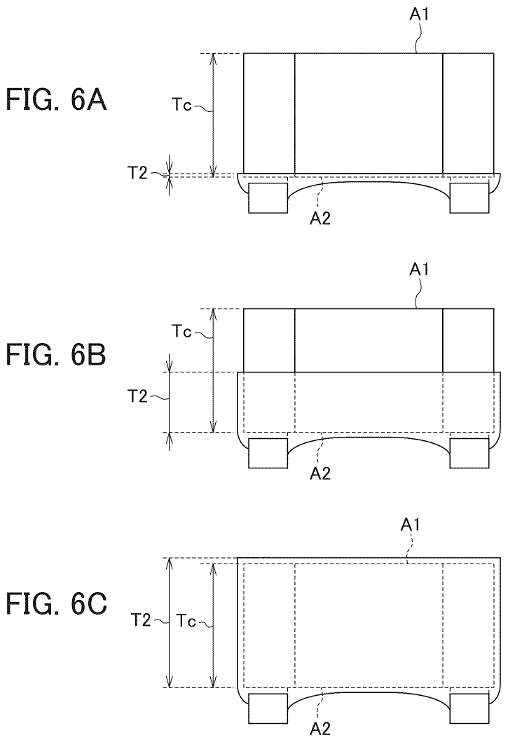

FIGS. 6A to 6C are diagrams explaining the covering state of the capacitor main body 1A by the capacitor-side covering portion 51 of the reinforcement portion 5. The capacitor-side covering portion 51 covers a predetermined length range in the lamination direction of the capacitor main body 1A adjacent to the second main surface A2. When the length of the capacitor main body 1A in the lamination direction is defined as Tc and the length of the capacitor-side covering portion 51 in the lamination direction is defined as T2, FIG. 6A shows that T2/Tc is, for example, about 0.05, FIG. 6B shows that T2/Tc is, for example, about 0.5, and FIG. 6C shows that T2/Tc is, for example, about 1.1.

The capacitor-side covering portion 51 of the reinforcement portion 5 may cover only a portion of the capacitor main body 1A as shown in FIGS. 6A and 6B, but it is preferable to cover the entire or substantially the entire capacitor main body 1A as shown in FIG. 6C. That is, it is preferable that the reinforcement portion 5 covers a portion of the spacers 4 and the entire or substantially the entire capacitor main body 1A. By covering the entire or substantially the entire capacitor main body 1A with the reinforcement portion 5, it is possible to improve the cushioning property of the reinforcement portion 5, and it is possible to improve the impact resistance when an impact is applied to the multilayer ceramic capacitor 1.

### Measurement Method

The measurement of the length of the reinforcement portion 5 in the lamination direction T described above can be performed, for example, as follows. In a case where the multilayer ceramic capacitor 1 is bonded to a wiring board with solder, the multilayer ceramic capacitor 1 bonded to the wiring board with solder is polished in the width direction W until the LT cross-section where the multilayer ceramic capacitor 1 and the reinforcement portion 5 are visible. Then, using a microscope (e.g., BX-51, manufactured by Olympus) connected to a digital camera for microscopes (e.g., DP22, manufactured by Olympus), the length of the reinforcement portion 5 in the lamination direction T is measured with an appropriate magnification such as about 10 times to about 50 times.

### Advantageous Effects of Reinforcement Portion 5

According to an example embodiment of the present invention, the multilayer ceramic capacitor includes the reinforcement portion 5 including the spacer-side covering portion 52 that covers, for example, about 4.9% or more of each of the two spacers in the lamination direction T, and a capacitor-side covering portion 51 that continuously extends from the spacer-side covering portion 52 to cover a portion of the outer periphery of the capacitor main body 1A adjacent to the spacers. This makes it possible to ensure resistance to substrate bending, while maintaining the advantageous effect of reducing or preventing acoustic noise.

In addition, in each of the spacers 4, the spacer-side covering portion 52 of the reinforcement portion 5 continuously covers the middle-side spacer end surfaces SC1 of the two spacer end surfaces SC, and the two spacer lateral surfaces SB. This makes it possible to increase the area where the reinforcement portion 5 covers the spacers 4, making it possible to further strengthen the resistance to substrate bending.

Furthermore, when the reinforcement portion 5 covers the entire or substantially the entire capacitor main body 1A, it is possible to further strengthen the resistance to substrate bending.

### Method of Manufacturing Multilayer Ceramic Capacitor 1

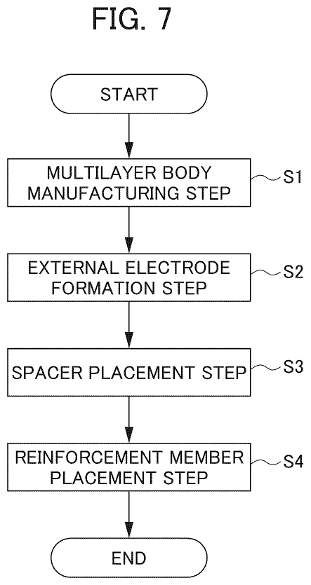

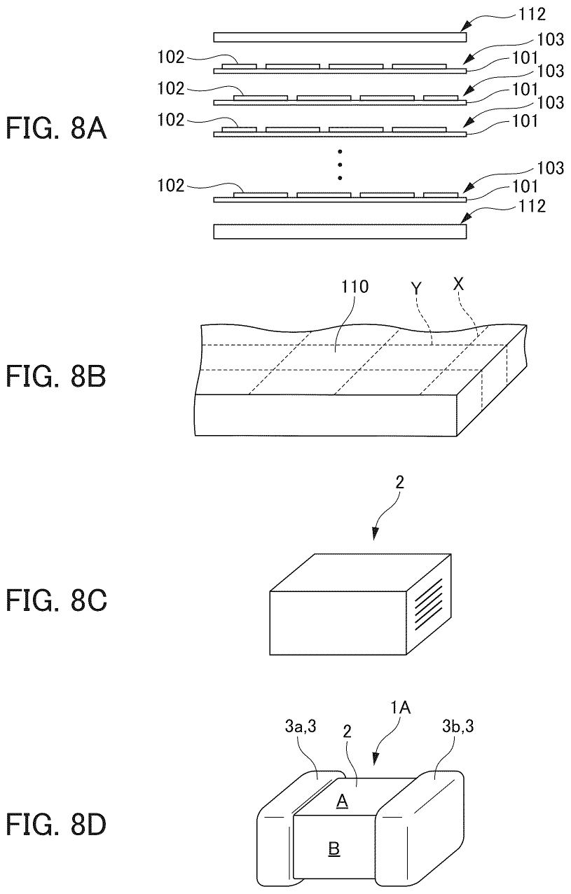

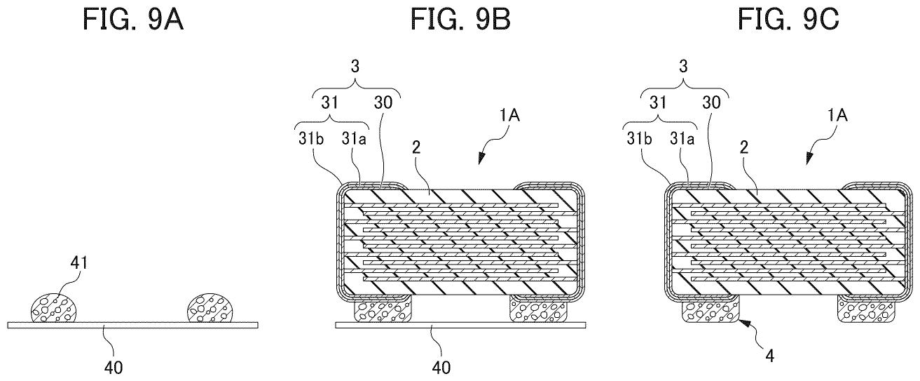

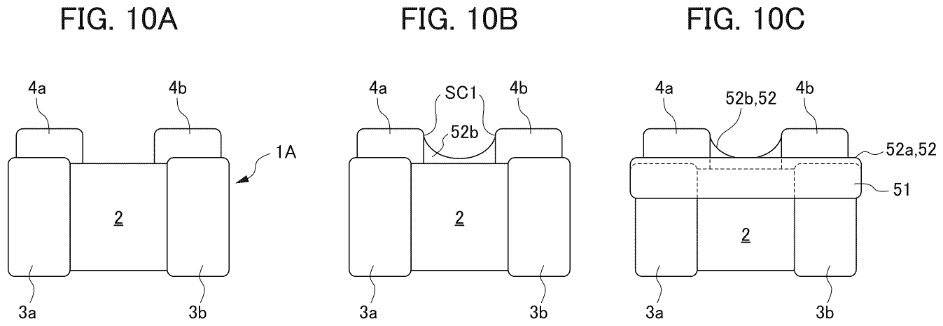

FIG. 7 is a flowchart explaining an example of a method of manufacturing the multilayer ceramic capacitor 1 according to an example embodiment of the present invention. The method of manufacturing the multilayer ceramic capacitor 1 includes a multilayer body manufacturing step S1, an external electrode formation step S2, a spacer placement step S3, and a reinforcement portion placement step S4. FIGS. 8A to 8D are diagrams explaining the multilayer body manufacturing step S1 and the external electrode formation step S2. FIGS. 9A to 9C are diagrams explaining the spacer placement step S3. FIGS. 10A to 10C are diagrams explaining the reinforcement portion placement step S4.

### Multilayer Body Manufacturing Step S1

A ceramic slurry including ceramic powder, binder, and solvent is formed into a sheet on the surface of a carrier film using, for example, a die coater, gravure coater, micro gravure coater, etc., to create a multilayer ceramic green sheet 101 that defines and functions as the dielectric layer 14. Next, a material sheet 103 is created by printing an electrically conductive paste in a strip pattern on the multilayer ceramic green sheet 101 by, for example, screen printing, inkjet printing, gravure printing, etc., and printing an electrically conductive pattern 102 that defines and functions as the internal electrode layer 15 on the surface of the multilayer ceramic green sheet 101.

Next, as shown in FIG. 8A, a plurality of material sheets 103 are stacked such that the electrically conductive patterns 102 face in the same direction and the electrically conductive patterns 102 are offset from each other by, for example, about half a pitch in the length direction L between adjacent material sheets 103. Furthermore, ceramic green sheets 112 for outer layer portions, which will define and function as the outer layer portions 12, are stacked on both sides of the plurality of stacked material sheets 103.

The plurality of stacked material sheets 103 and the ceramic green sheets 112 for outer layer portions are pressed together using, for example, a hydrostatic press or the like to create a mother block 110 as shown in FIG. 8B.

Next, the mother block 110 is cut along cutting lines X and cutting lines Y that intersect the cutting lines X as shown in FIG. 8B to manufacture a plurality of multilayer bodies 2 as shown in FIG. 8C.

### External Electrode Formation Step S2

Next, a base electrode layer 30 is formed by, for example, applying and firing an electrically conductive paste including copper (Cu) to the end surfaces C of the multilayer body 2. The base electrode layer 30 extends not only on both end surfaces C of the multilayer body 2, but also to the main surfaces A and lateral surfaces B, so as to cover a portion of the main surfaces A adjacent to the end surfaces C. Then, a plated layer 31 is formed on the surface of the base electrode layer 30, including, for example, a nickel (Ni) plated layer 31a and a tin (Sn) plated layer 31b provided on the surface of the nickel (Ni) plated layer 31a, to manufacture a capacitor main body 1A as shown in FIG. 8D.

### Spacer Placement Step S3

A spacer manufacturing paste 41 for manufacturing spacers is prepared. The spacer manufacturing paste 41 includes metals such as, for example, copper (Cu), nickel (Ni), tin (Sn), and silver (Ag), a phenol resin, solvent, and additives. In this case, for example, rosin may be included instead of phenol resin.

Examples of the phenol resin include novolac-type phenol resins such as a phenol novolac resin, a phenol aralkyl resin, a cresol novolac resin, a tert-butylphenol novolac resin, a nonylphenol novolac resin, a resol-type phenol resin, or polyoxystyrenes such as polyparaoxystyrene, or the like.

FIGS. 9A to 9C are diagrams explaining the spacer placement step S3. As shown in FIG. 9A, first, the spacer manufacturing paste 41 is provided on a holding substrate 40 by, for example, a screen printing method, dispensing method or the like.

Next, as shown in FIG. 9B, the capacitor main body 1A is mounted on the upper surface of the holding substrate 40 in a posture where the second main surface A2 is opposed to the holding substrate 40. At this time, the external electrode 3 of the capacitor main body 1A is aligned with the spacer manufacturing paste 41, and the spacer manufacturing paste 41 adheres to the capacitor main body 1A.

In this state, a heating step is performed. When at least a portion of the metal in the paste forms an intermetallic compound to form a metal region MP, a portion of the phenol resin is incorporated into the metal region MP while a portion thereof is discharged from the metal region MP, and the metal region MP is cured, such that a spacer 4 bonded to the capacitor main body 1A is formed.

In the above, a configuration including an intermetallic compound and a phenol resin is shown as an example of the spacer material, but this is not limited thereto, and it may include, for example, different types of metal components, or it may include resins other than a phenol resin such as an epoxy resin or rosin, or glass components. Also, it may be formed without including a resin.

Subsequently, as shown in FIG. 9C, the capacitor main body 1A together with the spacer 4 is separated from the holding substrate 40. The present invention is not limited to this manufacturing method, and it is also possible to directly place the spacer manufacturing paste in a desired shape on the surface of the capacitor main body 1A, perform heat treatment, and form the spacer.

### Reinforcement Portion Placement Step S4

FIGS. 10A to 10C are diagrams explaining the reinforcement portion placement step S4. First, the surface of the capacitor main body 1A on which the spacers 4 are provided is cleaned with a solvent. As shown in FIG. 10A, after the cleaning is completed, the capacitor main body 1A with the spacers 4 is aligned so that the spacers 4 face upward.

Next, as shown in FIG. 10B, an insulating resin layer defining and functioning as the middle portion 52b of the reinforcement portion 5 is formed between the first spacer 4a and the second spacer 4b on the capacitor main body 1A with the spacers 4, using, for example, a dispenser or squeegee printing. The amount of spreading onto the middle-side spacer end surface SC1 can be varied by changing the amount of an insulating resin.

In order to allow the insulating resin to penetrate into the interface between the spacer 4 and the multilayer body 2, it is possible to perform, for example, vacuum drawing after placing the insulating resin. The amount of penetration can be controlled by changing the time and pressure of the vacuum drawing.

Next, as shown in FIG. 10C, an insulating resin is applied to span across the periphery of the capacitor main body 1A and the periphery of the spacer 4. Then, by heating the applied insulating resin at, for example, about 100° C. to about 200° C. for about 20 minutes to about 80 minutes, the insulating resin cures to form a capacitor-side covering portion 51 on the periphery of the capacitor main body 1A and a spacer-side covering portion 52 on the periphery of the spacer 4. The multilayer ceramic capacitor 1 is manufactured through the above steps.

### Evaluation of Example Embodiments

Next, the results of evaluation 1 and evaluation 2 performed on the multilayer ceramic capacitor 1 provided with the reinforcement portion 5 of the present example embodiment will be described.

### Multilayer Ceramic Capacitor 1 Used for Evaluation

The following capacitor main body 1A was used.
Length direction L: about 1.6 mm
Width direction W: about 0.8 mm
Lamination direction T: about 0.8 mm
Main component of internal electrode: Ni
Dielectric layer: BaTiO₃
Main component of base electrode layer: Cu
First plated layer: Ni
Second plated layer: Sn

The components of the spacer 4 were as follows. About 31.5 wt % of Cu-10 wt % Ni powder with D50 (median diameter) of about 5 μm, about 58.5 wt % of solder powder with a composition of Sn-3 wt %, Ag-0.5 wt %, Cu with D50 of about 5 μm, and about 10 wt % of a total of rosin, solvent, and additive components.

The reinforcement portion 5 is an insulating resin including an epoxy resin as a main component and a phenol resin added as a curing agent.

### Evaluation 1

(1) Five types of multilayer ceramic capacitors 1 were prepared, with 10 pieces each, in which the length of the spacer-side covered portion 52 with respect to the length of the spacer 4 in the lamination direction T was 0%, about 1.2%, about 3.6%, about 4.9%, and about 13.5%.

Next, the multilayer ceramic capacitors 1 were mounted on an approximately 1.6 mm thick JIS substrate with lead-free solder, and held for about 5 seconds with a deflection amount of about 4 mm.

Then, in order to check for cracks in the multilayer ceramic capacitors 1, each of them was polished until the length in the width direction W was reduced to about ½.

The multilayer ceramic capacitors near the mounting surface were observed using a microscope (BX-51, manufactured by Olympus) connected to a digital camera for microscopes (DP22, manufactured by Olympus), with appropriate adjustments such as a total magnification of about 10 times.

The presence or absence of cracks generated in each of the multilayer ceramic capacitors 1 was confirmed, and those with a crack occurrence rate (number of multilayer ceramic capacitors 1 with cracks/number of multilayer ceramic capacitors 1 checked) of about 50% or more were marked as x (cross symbol indicating poor), and those with less than about 50% were marked as ∘ (circle symbol indicating good).

### Evaluation 2

The same multilayer ceramic capacitors used in Evaluation 1 were mounted on a mounting substrate and placed in an anechoic box.

A sound collection microphone was positioned to face the mounting substrate portion where the multilayer ceramic capacitors 1 were provided.

An alternating current with a frequency of about 3 kHz and a voltage of about 1 Vpp was applied to the multilayer ceramic capacitors 1, and the acoustic noise level of the multilayer ceramic capacitors 1 was measured by the sound collection microphone. The acoustic noise of the multilayer ceramic capacitor 1 was collected by the sound collection microphone, and the output of the sound collection microphone was inputted through a sound meter to an FFT (Fast Fourier Transform) analyzer, where the sound pressure level was analyzed.

Using the sound pressure level of the multilayer ceramic capacitor 1 as a reference, those with less than about 10% improvement were marked as A (triangle symbol indicating fair), and those with about 10% or more improvement were marked as o (circle symbol indicating good).

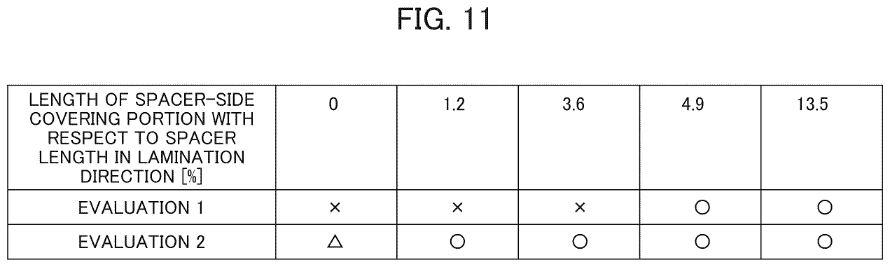

FIG. 11 is a table showing the results of Evaluation 1 and Evaluation 2 for the multilayer ceramic capacitors 1, each provided with the reinforcement portion 5 according to the example embodiments. As shown in Evaluation 1, in the example embodiments where the length of the spacer-side covering portion 52 with respect to the spacer length in the lamination direction T was about 4.9% and about 13.58, the crack occurrence rate was less than about 50%, while in the comparative examples where the length of the spacer-side covering portion 52 with respect to the spacer length in the lamination direction T was 08, about 1.2%, and about 3.6%, the crack occurrence rate was about 50% or more.

As shown in Evaluation 2, the configuration in which the reinforcement portion 5 was provided exhibited improved results in the sound pressure level. In particular, when the length of the spacer-side covering portion with respect to the spacer length in the lamination direction was about 1.2% or more, including about 4.9% or more of the example embodiments, the crack occurrence rate was improved by about 10% or more.

As shown in the above evaluation results, it is demonstrated that the multilayer ceramic capacitors 1 according to the example embodiment described above reduced crack occurrence rate and also reduced the occurrence of acoustic noise.

In the above, a configuration including intermetallic compounds and rosin is shown as an experimental example of the spacer material. However, the present invention is not limited thereto, and may include different types of metal components, or may include about, resins such as an epoxy resin and a phenol resin, or glass components in addition to rosin.

Also, it may be formed without including a resin.

Although example embodiments of the present invention have been described above, the present invention is not limited to the example embodiments, provided in various configurations without departing from the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a capacitor main body including:
a multilayer body including dielectric layers and internal electrode layers laminated, two main surfaces opposed to each other in a lamination direction, two end surfaces opposed to each other in a length direction intersecting the lamination direction, and two lateral surfaces opposed to each other in a width direction intersecting the lamination direction and the length direction; and
two external electrodes each on a corresponding one of the two end surfaces, each connected to the internal electrode layers, and each extending to the two main surfaces and covering a portion of each of the two main surfaces;
two spacers on one of the two main surfaces of the capacitor main body, and being respectively adjacent to one of the two end surfaces and adjacent to an other of the two end surfaces, each of the spacers including two spacer main surfaces opposed to each other in the lamination direction, two spacer end surfaces opposed to each other in the length direction, and two spacer lateral surfaces opposed to each other in the width direction; and
a reinforcement portion; wherein
the reinforcement portion includes a spacer-side covering portion covering about 4.9% or more of a length in the lamination direction of the spacer, and a capacitor-side covering portion continuously extending from the spacer-side covering portion to cover a periphery of the capacitor main body adjacent to the two spacers; and
the spacer-side covering portion continuously covers opposing spacer end surfaces opposed to each other between the two spacers, and the spacer lateral surfaces in the spacer.

2. The multilayer ceramic electronic component according to claim 1, wherein
each of the two spacers includes the two spacer main surfaces opposed to each other in the lamination direction, the two spacer end surfaces opposed to each other in the length direction, and the two spacer lateral surfaces opposed to each other in the width direction; and
the spacer-side covering portion of the reinforcement portion covers an outer-side spacer end surface on an outer side in the length direction of the multilayer body.

3. The multilayer ceramic electronic component according to claim 1, wherein the reinforcement portion covers an entirety or substantially an entirety of the capacitor main body.

4. The multilayer ceramic electronic component according to claim 1, wherein a direction identification mark is provided on the multilayer body.

5. The multilayer ceramic electronic component according to claim 1, wherein a direction identification mark is provided on at least one of the two spacers.

6. The multilayer ceramic electronic component according to claim 2, wherein the reinforcement portion covers an entirety or substantially an entirety of the capacitor main body.

7. The multilayer ceramic electronic component according to claim 2, wherein the spacer-side covering portion continuously covers the outer-side spacer end surface and the external electrode.

8. The multilayer ceramic electronic component according to claim 1, wherein the reinforcement portion includes a spacer-side covering portion covering about 4.9% or more and less than 100% of a length in the lamination direction of the spacer.

9. The multilayer ceramic electronic component according to claim 1, wherein the reinforcement portion is not present on a mounting-side spacer main surface.

10. The multilayer ceramic electronic component according to claim 1, wherein a length of each of the spacers in the length direction is greater a corresponding one of the external electrodes.

11. The multilayer ceramic electronic component according to claim 1, wherein each of the spacers includes copper or nickel as a metal powder and tin.

12. The multilayer ceramic electronic component according to claim 11, wherein the metal powder is coated with silver.

13. The multilayer ceramic electronic component according to claim 1, wherein each of the spacers includes an intermetallic compound including tin added to copper or nickel.

14. The multilayer ceramic electronic component according to claim 1, wherein each of the spacers includes an intermetallic compound including tin added to an alloy of copper and nickel.

15. The multilayer ceramic electronic component according to claim 11, wherein the metal powder include phenol resin.

16. The multilayer ceramic electronic component according to claim 15, wherein an area ratio of the phenol resin in each of the spacers is about 1% or more and about 20% or less.

17. The multilayer ceramic electronic component according to claim 15, wherein an area ratio of the phenol resin in each of the spacers is about 5% or more and about 15% or less.

18. The multilayer ceramic electronic component according to claim 1, wherein each of the spacers has a void ratio of about 20% or less in a region within about 5 μm from an interface with a corresponding one of the external electrodes.

19. The multilayer ceramic electronic component according to claim 1, wherein only a mounting-side spacer main surface is exposed from the reinforcement portion.
